(19) United States
(12) Patent Application Publication
(10) Pub. No.: US 2003/0178096 A1
(43) Pub. Date: Sep. 25, 2003

(54) Nozzle with safe functionning and filling installation incorporating such a nozzle

(75) Inventors: Jean-Jacques Lacroix, Lovagny (FR); Maurice Ravaz, Faverges (FR)

Correspondence Address: DOWELL & DOWELL PC, SUITE 309, 1215 JEFFERSON DAVIS HIGHWAY, ARLINGTON, VA, 22202

(73) Assignee: STAUBLI FAVERGES, Faverges (FR)

(21) Appl. No.: 10/388,478

(22) Filed: Mar. 17, 2003

(30) Foreign Application Priority Data
Mar. 19, 2002 (FR) 02 03388

(51) Int. Cl. B65B 57/14; B65B 57/06; B65B 3/28; B67C 3/00; B65B 1/30

(52) U.S. Cl. 141/206

(57) ABSTRACT

The filling nozzle according to the invention is provided with a ring for fastening on an adaptor connected to a container and with a controlled valve adapted to selectively obturate a conduit for flow of a fluid. A sensor for detecting the fastening of the nozzle on an adaptor makes it possible, as a function of the fastening, to render a kinematic link between a control member and the valve active, this link making it possible, in active configuration, to displace the valve from a position where it obturates the conduit towards a position where it leaves a passage free for the fluid in the conduit. The control member is a trigger provided with a notch which comprises two parts in which may slide an element fast with a lever articulated on the valve. Depending on the part where this element slides, a transmission of effort between the trigger and the lever is, or is not, possible.

### FIELD OF THE INVENTION

The present invention relates to a nozzle for filling a container with a fluid under pressure. The invention also relates to an installation for filling an automobile vehicle tank with liquefied petroleum gas, in which such a nozzle is used.

### BACKGROUND OF THE INVENTION

It is known, for example from U.S. Pat. No. 5,904,302, to use a bayonet-type system for ensuring fixation of a kerosene filling adaptor on an aircraft. As a function of the interlocking, a lever may block a valve located in this adaptor. Such bayonet-type interlocking is delicate to carry out and the use of this complex system is, in practice, reserved for specialists working in airport zones.

In the domain of the dispensing of liquefied petroleum gas (LPG) as fuel for automobile vehicle, it is known that serious precautions must be taken to avoid gas spreading in the ambient atmosphere. In particular, it is imperative that a tight connection be made between the dispensing device, or pump, and the tank of the vehicle. In the known devices, the user must place an end adaptor of a flexible hose pipe on an adaptor located on the vehicle then activate a lever to lock these adaptors. The user must then return to the pump to control an electrovalve allowing the hose pipe to be supplied with gas under pressure. These known manoeuvres are not convenient and can disconcert an inexperienced user.

In addition, in the known devices, interlocking of the end of the hose pipe on the adaptor of the vehicle is generally effected thanks to a claw system which is complex, and consequently unreliable. Such a claw system may be poorly engaged on the adaptor of the vehicle, hence a risk of offset connection that may lead to leakages of gas.

The devices used in the domain of filling automobile vehicle tanks with LPG must, in addition, be compatible with the standardized adaptors mounted on the vehicles.

It is a particular object of the present invention to overcome these limitations by proposing a nozzle for filling a container, particularly adapted to the dispensing of LPG, which makes it possible to deliver a fluid in tight manner, while ensuring that no fluid is spread in the atmosphere as long as the nozzle is not connected to the adaptor with which it must cooperate, even if the user exerts an effort on the trigger.

Another object of the invention is to propose a nozzle such that the rejects of fluid when it is disconnected from the adaptor are minimized.

### SUMMARY OF THE INVENTION

To that end, the present invention relates to a nozzle for filling a container with a fluid under pressure, this nozzle being provided with a means for fastening on an adaptor connected on the container, with a controlled valve adapted to selectively obturate a conduit for flow of the fluid, and with a sensor detecting the fastening of the nozzle on an adaptor, this sensor being adapted, as a function of this fastening, to render active a kinematic link between a control member and the valve, this link making it possible, in active configuration, to displace the valve from a position where it obturates the conduit towards a position where it leaves a passage free for the fluid in this conduit, while, in non-active configuration of the link, the valve cannot be actuated by means of the afore-mentioned member. The kinematic link comprises a lever, articulated on the valve, between a first position where it is not displaceable by the control member and a second position where it may be displaced by this member, taking along the valve, the sensor being adapted to displace the lever from its first towards its second position. The control member is a trigger articulated on the nozzle and provided with at least one cut-out, notch or groove whose profile forms a first part which makes it possible to receive an element fast with the lever without noteworthy interaction between the lever and the trigger. The cutout, groove or notch also comprises a second part which has a geometry different from the first part and extends it, the element fast with the lever being adapted to slide along the profile of the first part of the cut-out, groove or notch, when the lever is in its first position, and to cooperate with the profile of the second part, when the lever is in its second position, with the result that it allows the transmission of an effort between the trigger and the lever.

Thanks to the invention, the kinematic link between the control trigger and the valve prevents the nozzle from allowing passage as long as it is not fastened on an adaptor. Fastening is detected thanks to the lever which is fast with an element allowing the trigger to be passed from a configuration where it is “'idle” to a configuration where it is “active”. In the idle configuration, the afore-mentioned element cooperates with the profile in its first part, while it cooperates with the profile in its second part when the trigger is in active configuration.

According to advantageous but non-obligatory aspects of the invention, a nozzle may incorporate one or more of the characteristics set forth in the dependent Claims.

The invention also relates to an installation for filling an automobile vehicle tank with liquefied petroleum gas, which incorporates a nozzle as described hereinabove and envisaged hereinafter.

### BRIEF DESCRIPTION OF THE DRAWINGS

The invention will be more readily understood on reading the following description of a form of embodiment of a nozzle and of an installation in accordance with its principle, given solely by way of example and made with reference to the accompanying drawings, in which:

FIG. 1 schematically shows an installation according to the invention of which the nozzle and the adaptor with which it cooperates are shown in longitudinal section.

FIG. 2 is a view on a smaller scale of the nozzle and the adaptor of FIG. 1, when the nozzle is being fastened on the adaptor.

FIG. 3 is a view similar to FIG. 2, when the nozzle is fastened on the adaptor.

FIG. 4 is a view in perspective of the adaptor and of the internal elements of the nozzle in the configuration of FIG. 3.

FIG. 5 is a view similar to FIG. 2 and to the scale of FIG. 1, when the trigger of the nozzle is controlled so that fluid flows, and

FIG. 6 is a view of the type of FIG. 4 when the nozzle is in the configuration of FIG. 5.

### DESCRIPTION OF PREFERRED EMBODIMENT

Referring now to the drawings, the nozzle 1 shown therein is connected on the downstream end of a flexible hose pipe 2 of which the upstream end is connected to a pump 3 for dispensing liquefied petroleum gas.

The nozzle 1 is intended to cooperate with adaptors such as the adaptor 4 shown in the Figures which is mounted on an automobile vehicle 5 and which is connected, via a conduit 6 integrated with the vehicle 5, to a liquefied gas tank 7.

The adaptor 4 is equipped with a valve 8 elastically loaded by a spring 9 in the direction of a part 10 of the adaptor 4 forming seat.

On its outer peripheral surface, the adaptor 4 is provided with a groove 11 of flared shape as well as with an indent 12 separated from the groove 11 by a flange 13.

The nozzle 1 comprises a body 20 inside which is housed a pipe 21 connected to an angle 22 of which the opening 22a in the form of a convergent part communicates with a volume 23 for receiving the adaptor 4 in the body 20. The volume 23 has a shape adapted to the outer shape of the adaptor 4 and is equipped with an O-ring 24 for abutment of an end bevel 14 of the adaptor 4. Around the volume 23, the nozzle 1 is equipped with a ring 25 for retaining the adaptor 4 in the volume 23. This ring 25 is elastically loaded by a spring 26 exerting thereon an effort F₁ perpendicular to a longitudinal axis X-X′ of the adaptor 4 and of the volume 23 when the latter are opposite or engaged with respect to each other, as represented in the Figures.

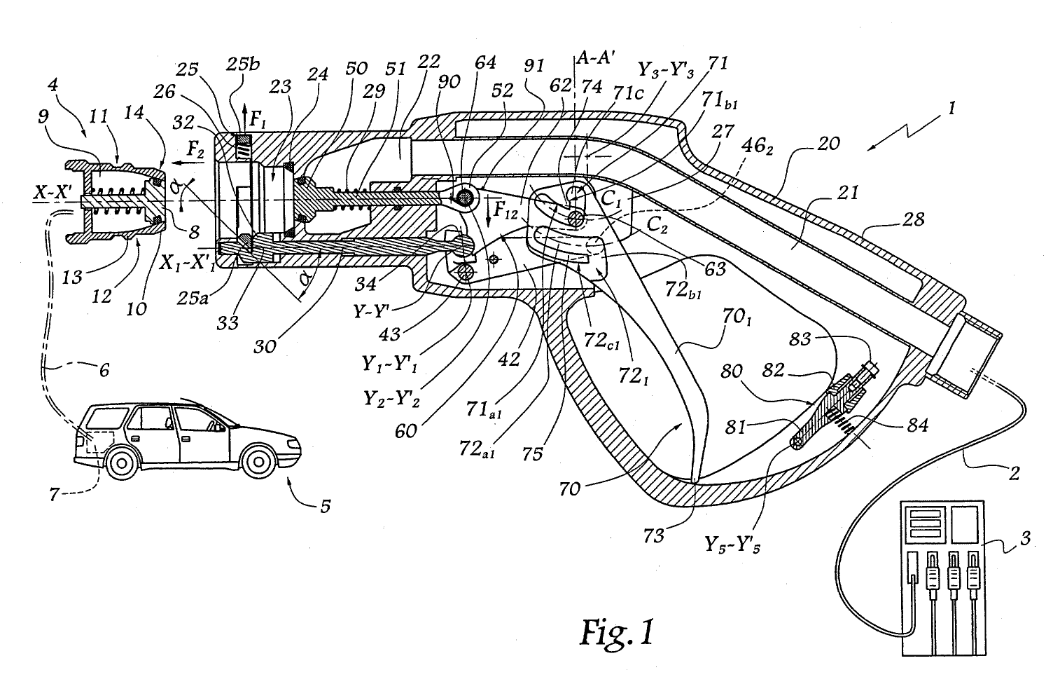

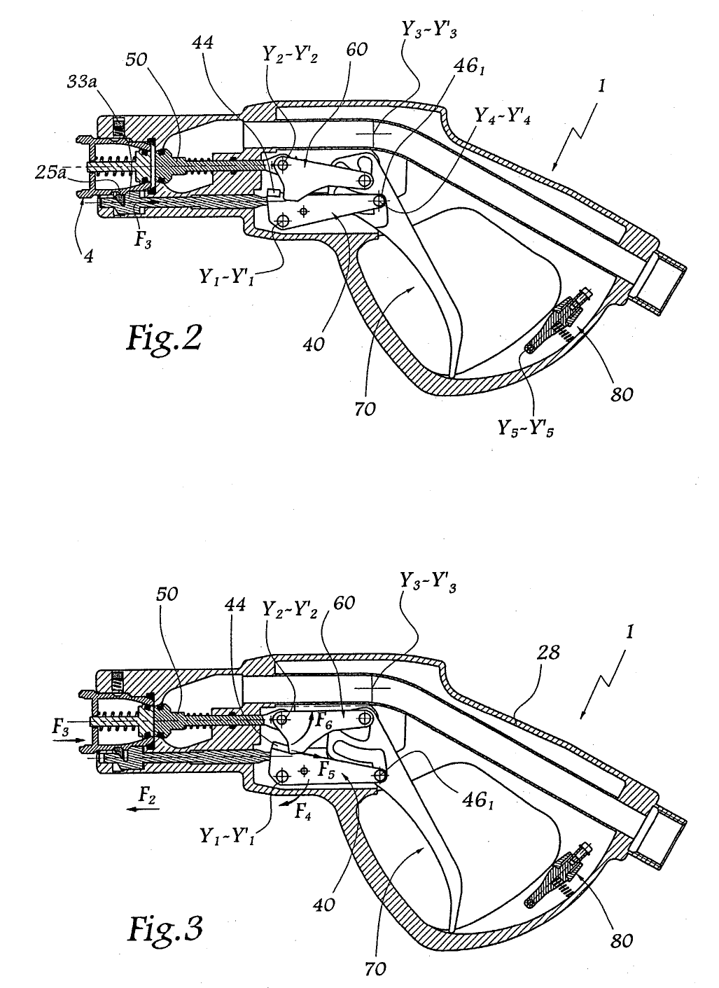

When the nozzle 1 is displaced towards the adaptor 4 in the direction of arrows F₂ in FIGS. 1 to 3, the flange 13 pushes the ring 25 against the effort F₁, as represented in FIG. 2, then the ring 25 engages in the groove 13, under the effect of the effort F₁, as represented in FIG. 3.

The elements 25 and 26 therefore constitute means for fastening the nozzle 1 on the adaptor 4.

A rod 30 is mounted, with the possibility of slide parallel to axis X-X′, in a housing 31 made in the body 20. This rod 30 comprises a nose 32 intended to come into engagement in the indent 12 of the adaptor 4. This rod also comprises a notch 33 for partially receiving a part 25a of the ring 25 opposite a part 25b on which the effort F₁ is exerted.

At the level of its end 34 opposite the parts 32 and 33, the rod 30 is articulated, about a geometrical axis Y-Y′, on a rocker 40 formed by two plates 41 and 42 embracing the end 34 and articulated on the body 20 about a geometrical axis Y₁-Y′₁ perpendicular to axis X-X′, this axis being materialized by a pin 43 traversing the plates 41 and 42. Each of the plates 41 and 42 is provided with a heel 44, 45, respectively, of substantially parallelepipedic shape.

A valve 50 is mounted in the angle 22 and comes into abutment, under the effect of an elastic effort exerted by a spring 29, against the convergent part 22a forming the downstream part of the angle 22.

The valve 50 is extended by a rod 51 articulated about an axis Y₂-Y′₂ with a lever 60 formed by two plates 61 and 62 embracing the end 52 of the rod 51. The axes Y₁-Y′₁, and Y₂-Y′₂ are parallel.

The plates 61 and 62 have such a geometry that they come respectively opposite the heels 44 and 45.

The plates 41 and 61 have been added in FIGS. 2, 3 and 5 in order to render the drawing clearer.

Furthermore, a cylindrical pin 63 with circular cross-section is mounted through the plates 61 and 62 along an axis parallel to axis Y₂-Y′₂.

A trigger 70 is articulated on a support 27 fast with the pipe 21. Y₃-Y′₃ denotes the axis of articulation of the trigger 70, this axis being parallel to axis Y₁-Y′₁.

The trigger 70 is provided with a notch 71 which the pin 63 traverses and in which it may move.

The profile of this notch comprises a first part shaped as an arc of circle C₁ centred on axis Y₃-Y′₃. In this direction, part 71a is in the form of an arc of circle. The notch 71 also comprises a second part 71b with which part 71a communicates and which extends in a direction A-A′ substantially perpendicular to part 71a in the zone of join between these parts. The bottom of the part 71b forms a seat 71c in which the pin 63 may be retained.

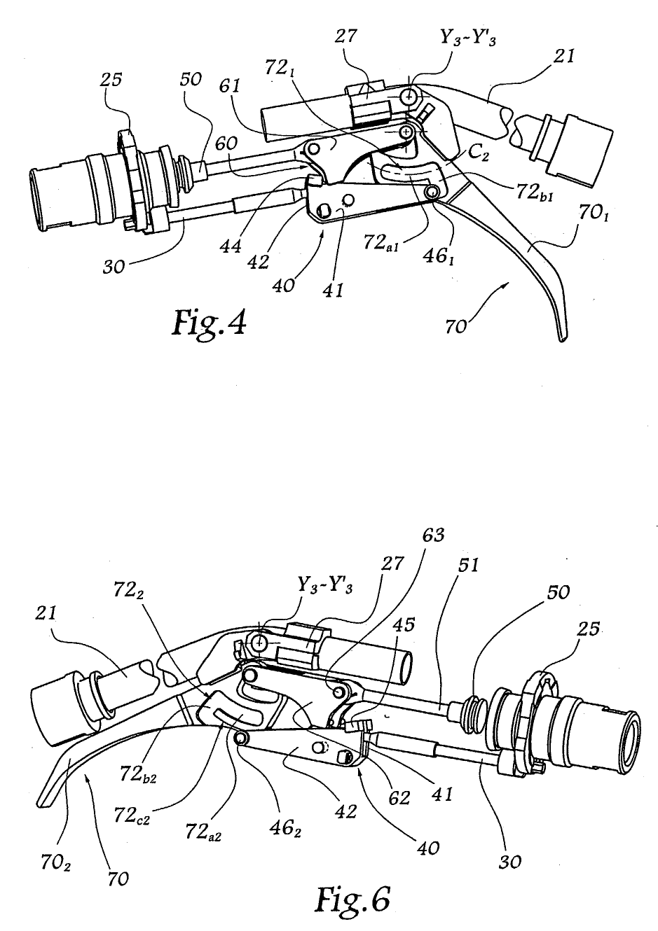

The trigger 70 is also provided, on its face 70₁ visible in FIGS. 1 to 5, with a groove 72 which comprises a first part 72a₁ substantially in the form of an arc of circle C₂ centred on axis Y₃-Y′₃, as well as a second, L-shaped part 72b₁ which communicates with the part 72a₁. A pin 46₁ is mounted on the plate 41 and extends, along axis Y₄-Y′₄ parallel to axis Y₁-Y′₁, towards the groove 72₁. The pin 46₁ is intended to slide in the groove 72₁.

On its opposite face 70₂, visible in FIG. 6, the trigger 70 is provided with a second groove 72₂ having the same geometry as the groove 72₁, with an arcuate part 72b₂ and an L-shaped part 72a₂. The plate 42 bears a pin 46₂ intended to slide in the groove 72₂.

Functioning is as follows:

When the nozzle 1 is fastened on the adaptor 4, as explained hereinabove, the nose 32 of the rod 30 is pushed in the direction of arrow F₃ in FIG. 3, which has the effect of causing the rod 30 to slide in the housing 31, in the direction of this arrow, a corresponding displacement of the end 34 being obtained. Such displacement has the effect of causing the rocker 40 to pivot about axis Y₁-Y′₁ in the direction of arrow F₄, to such a point that heels 44 and 45 come into abutment against the plates 61 and 62, which induces a pivoting of the lever 60 in the trigonometric direction in FIG. 3. The bearing effort of the heels 44 and 45 on the lever 60 is represented by arrow F₅ in FIG. 3, while the pivoting of this lever is represented by arrow F₆. Due to the pivoting of the lever 60, the pin 63 which, in the configuration of FIG. 1, is engaged in the part 71a of the groove 71, is displaced towards the part 71b in the direction of the seat 71c.

In this configuration, if the user exerts on the trigger 70 an effort F₇ towards the part forming handle 28 of the body 20, the trigger exerts, by the front edge 71b₁ of part 71b and on the pin 63 borne by the lever 60, an effort F₈ of traction resulting in a corresponding effort of traction F₉ on the valve, this effort having the effect of detaching the valve 50 from the convergent part 22a. This allows a flow E of fluid under pressure from its source 3 towards the tank 7 connected to the adaptor 4.

If the trigger 70 is released, the spring 29 pushes the valve 50 towards its seat 22a.

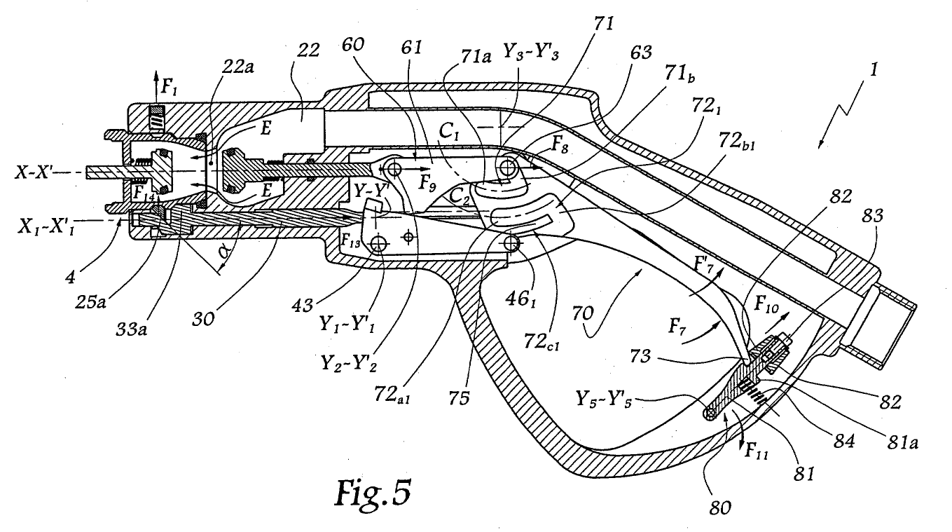

A device 80 is provided for temporarily blocking the trigger 70 in the configuration of FIG. 5. This device comprises an arm 81 articulated on the body 20 about an axis Y₅-Y′₅ parallel to axis Y₁-Y′₁ and a shuttle 82 mounted to slide on the arm 81 and retained in position thanks to a screw 83.

When the trigger 70 is subjected to the effort F₇, it displaces the shuttle 82 in the direction of arrow F₁₀ in FIG. 5, with the result that it is blocked against an outer radial shoulder 81a of the arm 81. When the flow E is to be stopped, an additional effort F′₇, of the same direction as effort F₇ but of greater intensity, may be exerted, which has the effect of bringing, by an overtravel, the shuttle 82 into abutment against the head of the screw 83, then of pivoting the arm 81 in the direction of arrow F₁₁ against an elastic effort exerted by a spring 84. The end 73 of the trigger 70 is then released with respect to the arm 81, the trigger 70 in that case being able to return towards the position of FIG. 3.

In this way, when the nozzle 1 is fastened on the adaptor 4, the flow of fluid can be controlled thanks to the trigger 70.

If the effort F₇ is exerted on the handle 70 in the configuration of FIG. 1, the pin 63 slides in the part 71 a of the notch 71 without an effort of traction being transmitted to the lever 60, with the result that the valve 50 remains in abutment against its seat formed by the convergent part 22a. In this configuration, the edge 71a₁ of part 71a closest to the axis Y₃-Y′₃ essentially defines the path of slide of the pin 63.

The active parts of the notch 71 are thus the edges 71a₁ and 71b₁ which are defined by the profile of a solid part 74 of the trigger 70.

Thus, it is not possible to manoeuvre the valve 50 as long as the kinematic link between the trigger 70 and the valve is not rendered active by the displacement of the lever 60 towards its position in which the pin 63 is engaged in part 71b of the notch 71.

A torsion spring 90 is disposed around the pin 64 constituting the physical axis of articulation between the end 52 of the valve 50 and the plates 61 and 62 of the lever 60, with the result that the end 91 of this spring exerts on the lever 60 an effort F₁₂ tending to return the lever 60 towards its position of FIG. 1.

In addition, the cooperation of the pins 46₁ and 46₂ and of the grooves 72₁ and 72₂ prevents a separation of the nozzle 1 and of the adaptor 4 when the valve 50 is detached from the convergent part 22a. In effect, when the pin 63 slides in the part 71a of the notch 71, the pins 46₁ and 46₂ may slide in the parts 72a₁ and 72a₂ of the grooves 72₁ and 72₂. On the other hand, when the heels 44 and 45 push the lever 60, as represented by arrow F₅ in FIG. 3, the pivoting F₄ of the rocker 40 has the effect of taking pins 46₁ and 46₂ in the parts 72b₁ and 72b₂ of the notches 71₁ and 72₂. Due to the displacement of the trigger 70 under the effect of the effort F₇, the pins 46₁ and 46₂ then each slide along a lateral surface 72c₁, 72c₂, respectively, of the notches 72₁ and 72₂. The pins 46₁ and 46₂ are in that case in abutment against the surfaces 72c₁ and 72c₂, with the result that the rocker 40 can no longer pivot about axis Y₁-Y′₁ in a direction opposite to arrow F₄.

The rocker 40 thus being locked by its cooperation with surfaces 72c₁ and 72c₂ in a configuration where its pins 46₁ and 46₂ are lowered, it exerts on the rod 30 an effort of traction F₁₃ which has the effect of firmly applying a surface 33a defining the notch 33 against a surface 25c of the ring 25.

The surface 33a is inclined by an angle α equal to about 45° with respect to a longitudinal axis X₁-X′₁ of the rod 30 which is parallel to axis X-X′. As for the surface 25c, it is inclined by the same angle α with respect to the axis X-X′, axes X₁-X′₁ and X-X′ being parallel to each other.

The effort F₁₃ is thus transmitted to the ring 25 in the form of an effort F₁₄ of the same direction and same sense as the effort F₁, this effort firmly maintaining the ring 25 in engagement in the groove 11.

In this way, it is impossible to withdraw the nozzle 1 from the adaptor 4 as long as the pins 46₁ and 46₂ remain respectively in abutment against the surfaces 72₁ and 72c₂, i.e. as long as it is possible to manoeuvre the valve 50 thanks to the trigger 70.

It will be noted that the valves 8 and 50 are in surface abutment against each other, which contributes to the seal of the coupling made between the elements 1 and 4. It is also noted that the valve 8 is pushed downstream under the effect of the pressure of the fluid circulating in the pipe 21 and in the angle 22.

The invention has been described with reference to its use in an installation for supplying LPG to an automobile vehicle, which is particularly advantageous. However, a nozzle according to the invention may be used in other types of installation supplying fluid under pressure in which a high degree of safety is sought.

The invention has been shown with levers or rockers 40 and 60 formed by two plates embracing the parts 34 or 52 with which they cooperate. Levers formed in one piece may be envisaged.

The invention has been shown with a notch 71 and grooves 72₁ and 72₂, but it may be carried out with a trigger provided with a notch of equivalent geometry in place of the grooves and/or with grooves in place of the notch. The possible grooves may be made on one face only of the trigger 70. The geometry of the grooves and notches is not limited to that shown in the Figures. In practice, the functional parts of these grooves are essentially the seat 71c and the bearing surfaces 72₁ and 72c₁. The other parts of these grooves are clearances intended to allow the displacement of the pins 46₁, 46₂ and 63, such clearances being able to take various shapes.

The invention has been shown with a notch 71 inscribed in the trigger 70 and having a substantially constant width which is adapted to the diameter of the pin 63 in order to allow its guiding. In a variant, two grooves may be formed on either side of the trigger 70 to receive fingers borne by the lever 60. According to another variant, the first and second parts 71a and 71b mentioned above may be formed by a cut-out made around a solid part similar to part 74, such cut-out being able to open out on the front edge of the trigger 70.

In any case, the profile of the cut-out, notch or groove provided on the trigger to receive the element fast with the lever makes it possible to obtain the two “idle” and “active” configurations of the trigger.

In the same way, the grooves 72₁ and 72₂ may be replaced by a cut-out or notch which traverses the trigger 70. There again, the profile of this groove, cutout or notch, which is defined in particular by the surfaces 72c₁ and 72c₂ which are adjacent to a central tongue 75, makes it possible to obtain the desired safe functioning.

What is claimed is:

1. Nozzle for filling a container with a fluid under pressure, said nozzle being provided with means for fastening on an adaptor connected to the container, with a controlled valve adapted to selectively obturate a conduit for flow of the fluid, and with a sensor detecting the fastening of the nozzle on an adaptor, said sensor being adapted, as a function of this fastening, to render active a kinematic link between a control member and said valve, said link making it possible, in active configuration, to displace the valve from a position where it obturates said conduit towards a position where it leaves a passage free for said fluid in said conduit, while, in non-active configuration of said link, the valve cannot be actuated by means of said control member, said kinematic link comprising a lever, articulated on said valve, between a first position where it is not displaceable by said control member and a second position where it may be displaced by said control member, taking along said valve, said sensor being adapted to displace said lever from said first towards said second position, wherein said control member is a trigger articulated on the nozzle and provided with at least one cut-out, notch or groove whose profile forms a first part adapted to receive an element fast with said lever without noteworthy interaction between said lever and said trigger, while a second part of said profile has a geometry different from that of said first part and extends it, said element being adapted to slide along the profile of the first part when said lever is in its first position, and to cooperate with the profile of said second part when said lever is in its second position, with the result that it allows the transmission of an effort between said trigger and said lever.

2. The nozzle of claim 1, wherein said cut-out, notch or groove is inscribed in said trigger and presents a substantially constant width allowing a guiding of said element in abutment on one or the other of its edges.

3. The nozzle of claim 1, wherein said first part is shaped substantially in the form of an arc of circle centred on an axis of articulation of said trigger.

4. The nozzle of claim 1, wherein said second part extends in a direction substantially perpendicular to said first part in the zone of join between these parts and forms a seat for retaining said element fast with said lever.

5. The nozzle of claim 1, wherein it comprises means for elastically returning said lever towards a position in which said element is engaged in the first part of said groove or notch.

6. The nozzle of claim 1, wherein it comprises means for interlocking said fastening means, when said nozzle is in fastened configuration, on an adaptor, said interlocking means being adapted to lock said fastening means as a function of the configuration of said kinematic link.

7. The nozzle of claim 6, wherein said interlocking means comprise a rocker articulated on said sensor which is rigid, said rocker being adapted to exert on said sensor an effort transmitted by said sensor to said fastening means and resulting in their interlocking.

8. The nozzle of claim 7, wherein said fastening means comprise a ring adapted to surround an adaptor and to engage partially in a peripheral groove in said adaptor, said ring being provided with a surface inclined with respect to a central axis of said ring, said surface being adapted to come into abutment against a surface of said sensor inclined with respect to a direction of slide of said sensor, the transmission of said effort of said sensor towards said ring taking place by abutment between said surfaces.

9. The nozzle of claim 7, wherein said rocker is provided with at least one element in relief adapted to cooperate with a corresponding element in relief provided on said control member, the cooperation of said elements in relief maintainig said rocker in a position where it exerts said effort on said sensor.

10. The nozzle of claim 7, wherein said control member is a trigger provided with at least one cut-out, notch or groove adapted to receive an element fast with said rocker, said cut-out, notch or groove comprising a first part adapted to receive said element without noteworthy interaction between said rocker and said trigger, and a second part towards which said element is displaced when said kinematic link is rendered active, the positioning of said element in said second part maintaining the rocker in a position where, when said trigger is subjected to an effort of actuation for the displacement of said valve, said rocker exerts on said sensor said effort transmitted to said fastening means.

11. The nozzle of claim 10, wherein said first part is shaped substantially as an arc of circle centred on an axis of articulation of said trigger.

12. Installation for filling a tank of an automobile vehicle with liquefied petroleum gas, wherein it comprises a nozzle according to claim 1.
